(19) United States
(12) Patent Application Publication
(10) Pub. No.: US 2025/0083693 A1
(43) Pub. Date: Mar. 13, 2025

(54) AUTONOMOUS VEHICLE SENSOR SELF-HIT DATA FILTERING

(71) Applicant: GM Cruise Holdings LLC, San Francisco, CA (US)

(72) Inventors: Muhamad Muhamad Lotfy, Sammamish, WA (US); Cornelis Jacob Lekkerkerker, Walnut Creek, CA (US); Kaitlyn Williams, San Francisco, CA (US); Sandeep Gangundi, San Jose, CA (US)

(21) Appl. No.: 18/465,878

(22) Filed: Sep. 12, 2023

(51) Int. Cl. B60W 60/00; G06V 20/56

(52) U.S. Cl. CPC B60W 60/001; G06V 20/56; B60W 2420/403

(57) ABSTRACT

The present disclosure generally relates to detecting and filtering self-hit data from a sensor mounted to an autonomous vehicle and, more specifically, to identifying self-hit sensor data and generating and applying an image mask to filter out the self-hit sensor data. In some aspects, a method of the disclosed technology includes steps for collecting first sensor data for an environment around an autonomous vehicle (AV); identifying one or more data points, from the collected first sensor data, that correspond with a surface of the AV; generating an image mask representing the one or more data points that correspond with the surface of the AV; collecting second sensor data for the environment around the AV; and applying the image mask to the collected second sensor data. Systems and machine-readable media are also provided.

### BACKGROUND

### 1. Technical Field

The present disclosure generally relates to detecting and filtering self-hit data from a sensor mounted to an autonomous vehicle and, more specifically, to identifying self-hit sensor data and generating and applying a mask to filter out the self-hit sensor data.

### 2. Introduction

An autonomous vehicle is a motorized vehicle that can navigate without a human driver. An exemplary AV can include various image sensors, such as a camera sensor, a time-of-flight (TOF) sensor, a light detection and ranging (LiDAR) sensor, a radio detection and ranging (RADAR) sensor, and an ultrasonic sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at fixed locations on the autonomous vehicles.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1A illustrates an example frame generated from a scan using a sensor mounted to the exterior of an AV, according to some examples of the present disclosure;

FIG. 1B illustrates an example mask generated to filter out self-hit data, according to some examples of the present disclosure;

FIG. 2A illustrates an example frame before a mask has been applied to filter out the unwanted self-hit data, according to some examples of the present disclosure;

FIG. 2B illustrates an example frame after a mask has been applied to filter out the unwanted self-hit data, according to some examples of the present disclosure;

FIG. 3 illustrates a flow diagram of an example method for detecting and filtering self-hit data of a sensor using a mask, according to some examples of the present disclosure;

FIG. 4 illustrates a process for identifying self-hit sensor data and generating a mask to filter out the self-hit sensor data, according to some examples of the present disclosure;

FIG. 5 illustrates an example of a deep learning neural network that can be used to implement a model for detecting and filtering self-hit data from a sensor using a mask, according to some aspects of the disclosed technology; and

FIG. 6 illustrates an example system environment that can be used to facilitate autonomous vehicle (AV) dispatch and operations, according to some aspects of the disclosed technology;

FIG. 7 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

Some aspect of the present technology may relate to the gathering and use of data available from various sources to improve safety, quality, and experience. The present disclosure contemplates that in some instances, this gathered data may include personal information. The present disclosure contemplates that the entities involved with such personal information respect and value privacy policies and practices.

An autonomous vehicle (AV) is a motorized vehicle that can navigate roadways without a human driver. Collection of environmental sensor data, and accurately identifying objects around the AV based on the collected environmental sensor data, can be important for safe and efficient navigation of the AV. Environmental data collection can be performed using sensors disposed on the AV, such as using time-of-flight (TOF) sensors, light detection and ranging (LIDAR) sensors, or camera sensors mounted about the surface of the AV. A TOF sensor (also referred to as a TOF camera sensor or TOF camera) is a range imaging camera sensor system that measures the time it takes for a signal (e.g., a light pulse or electromagnetic continuous wave (CW)) to travel from the sensor to an object and back again. By measuring the time of flight of the signal, the TOF sensor can determine the distance between the sensor and the object, which allows the sensor to create a three-dimensional (3D) image of the scene or object being measured. As such, frames captured by TOF sensors can be used to estimate depth information of targets in a scene. For example, an internal computing system of an AV can use a TOF sensor to measure a distance of each pixel in a frame captured by the TOF sensor relative to the TOF sensor. The distance information can be used to obtain a representation of the spatial structure, distance, and/or geometry of a scene and/or a target in the scene.

However, one problem encountered in performing effective data capture is that the sensors can record unwanted sensor data received from the reflection of the AV itself, rather than from the surrounding environment. This unwanted sensor data (e.g., self-hit data) can deceive the AV into believing that one or more objects exist in the AV environment that do not really exist. This can cause confusion regarding the status and location of objects proximate the AV as the AV attempts to navigate the environment. As used herein, self-hit or self-hit data refers to data associated with measurements located on, or reflected from, a surface of the AV. Aspects of the disclosed technology provide solutions for identifying self-hit data, and generating and applying a mask filter to the frames captured by the sensor to filter out the self-hit data. For example, one or more TOF sensors can be configured to collect sensor data of the surrounding environment. It is understood that although a TOF sensor is provided as an example of an AV sensor herein, any number of sensors, or different sensor types, may be implemented, without departing from the disclosed technology.

In the case where TOF sensors are used, sensor data can comprise data indicating a distance between the sensor and an object based on the time it takes for a signal to travel from the sensor to the object and back again. To help distinguish between valid environmental sensor measurements (e.g., detecting objects located in the AV environment), and those measurements located on, or reflected from, a surface of AV (e.g., self-hit data), machine learning models can be used to identify AV boundaries. For example, machine learning models can be trained to identify self-hit data, and generate and apply a mask to the sensor frames to filter out unwanted self-hit data.

One or more sensors can be mounted to the exterior of the AV at fixed locations and in fixed positions. In some examples, a portion of the sensor field of view can face inward toward the body of the AV, thereby unintentionally detecting the body of the AV during each scan. Light waves that are reflected off the body of the AV itself can be considered self-hit and can be undesirable. For example, due to the highly reflective surface of AVs, light waves reflected off the AV itself (e.g., self-hit) can cause multipath reflections leading to odd and unusual artifacts in the processed frame data. The computing system of the AV can misinterpret these unwanted artifacts as physical objects located in the environment of the AV. Therefore, it can be important to identify self-hit data and filter out this unwanted self-hit data from the frames. Due to the fact that the sensors (such as, for example, TOF or LIDAR sensors) can be positioned in fixed locations about the body of the AV, the self-hit data generated by a given sensor can appear in the same location on each frame, each time the sensor completes a scan. Therefore, a machine learning model can be trained to identify artifacts within frames that appear in the same location in each and every frame as self-hit data. Machine learning models can determine the number of frames comprising an identical, static artifact that is sufficient to distinguish between a real stationary object detected in the AV environment and an artifact of self-hit data. Once the machine learning model has identified self-hit data for a particular sensor, the machine learning model can generate a fixed binary mask effectively blocking the self-hit data and subsequently apply the generated mask to the received frames to filter out the unwanted self-hit data. The process of training the machine learning model can include first providing labeled data frames to the machine learning model that include ground-truth boundaries that separate the AV from the environment. Then, subsequently updating the machine learning model based on a loss function (for example, the difference between the machine learning model's predicted boundary and the boundary indicated by the ground-truth data).

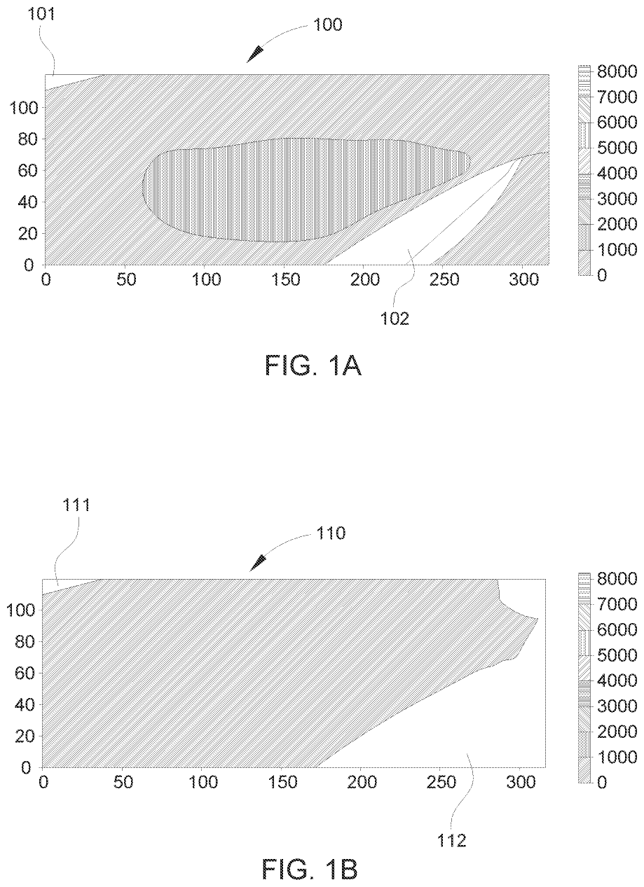

FIG. 1A illustrates an example frame 100 generated from a scan using a sensor mounted to the exterior of an AV. Frame 100 includes self-hit data 101 (e.g., the darkened corner) and self-hit data 102 (e.g., the elongated feature). That is, each time the scanner scans the location illustrated in frame 100 it will detect objects in that field of view, as well as a portion of the AV itself (e.g., self-hit data 101 and self-hit data 102). In some examples, frame 100 is merely a single frame of hundreds (or thousands, or more) that have been produced based on sensor data received from the sensor positioned at that location of the AV. Because of the fixed nature of the location of the sensor, each and every frame of the field of view shown in frame 100 will show the same portion of the AV in the same location of the frame (e.g., self-hit data 101 and self-hit data 102). A machine learning model can therefore be trained to identify these recurring objects located in the same location in every frame of this field of view (e.g., self-hit data 101 and self-hit data 102) as undesirable self-hit data. Once the machine learning model has determined the location of self-hit data for a particular sensor, a machine learning model can generate and apply a binary mask to the frames (such as frame 100, for example) to filter out the self-hit data, as shown in FIG. 1B.

FIG. 1B illustrates an example mask 110 that has been generated to filter out the self-hit data (e.g., self-hit data 101 and self-hit data 102) identified in frame 100. In some examples, a machine learning model can be trained to generate a binary mask based on the identified self-hit data. For example, mask 110 shows mask portion 111 and mask portion 112 that, when overlayed onto frame 100, will block the unwanted self-hit data (e.g., self-hit data 101 and self-hit data 102). The machine learning model can be trained to identify a boundary between the body of the AV and the environment, and that boundary can be used to generate a mask (e.g., mask 110) that can be applied to subsequently collected sensor frames. In view of the static location of each sensor positioned about the AV, a mask can be generated for a particular sensor and the same mask can be applied to each and every frame of that sensor until the sensor itself is physically moved. Any method can be used to apply the generated mask 110 to the frames (e.g., frame 100) such as, for example, multiplying the mask matrix against the collected field to zero-out the unwanted self-hit data. In some examples, the mask can be applied during operation of the AV stack, as discussed in more detail below. Another aspect of the static location of each sensor on the AV, is that a mask can be generated and maintained for each sensor mounted on the AV. For example, each sensor can have a mask associated with that specific sensor (which is different than the mask for each other sensor of the AV).

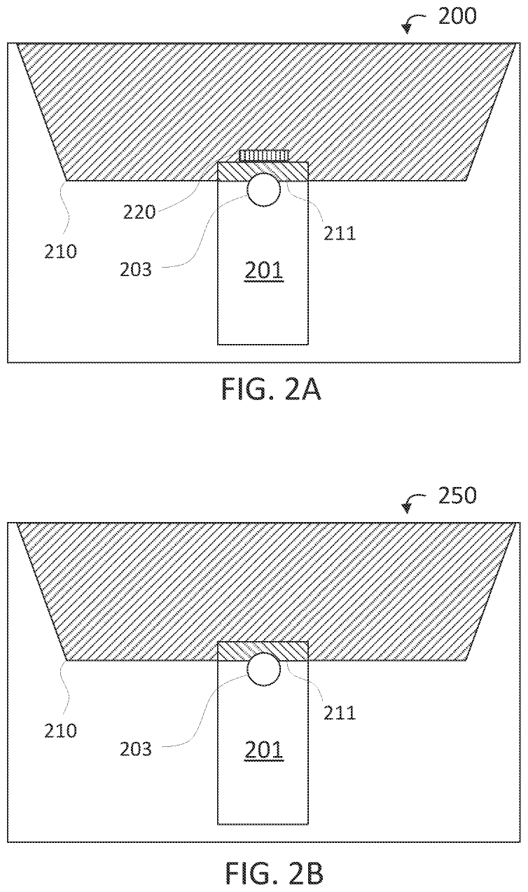

FIG. 2A illustrates an example frame 200 before a mask has been applied to filter out the unwanted self-hit data. For example, frame 200 illustrates AV 201 and sensor 203 and the surrounding point cloud data (e.g., portion 210, portion 211, and portion 220) generated from sensor data. For example, point cloud data portion 210 can comprise point cloud data representing the area around the AV 201, point cloud data portion 211 can comprise point cloud data representing reflections off the hood of AV 201, and point cloud data portion 220 can comprise point cloud data representing an unwanted artifact that exists due the self-hit reflected off the hood of AV 201. This unwanted artifact 220 can confuse the AV into believing that objects exist in the environment that are not really there. FIG. 2B illustrates an example frame 250 after a mask has been applied to filter out the unwanted self-hit data. As shown in FIG. 2B, the unwanted artifact (e.g., point cloud data portion 220) is no longer present in the frame. The lack of this unwanted artifact (e.g., point cloud data portion 220) can be important for the AV to accurately understand the environment around it when navigating the environment.

In some examples, it can be helpful to perform a mask dilation after the mask has been generated to account for slight errors in sensor calibration and/or slight unintended movement of the sensor as it travels through an environment. In some cases, mask dilation can be the process of increasing the size of the mask (by a few extra pixels) within the frame mask to account for these errors and/or unintended movement of the sensor. For example, as the AV travels along a roadway it can hit a large pothole that can bump the location of one or more sensors positioned on the AV. Dilating the mask can account for these types of minor adjustments to the sensors. In some scenarios, however, a sensor can be moved far enough from its original location that even a dilated mask may not account for all of the self-hit data that the sensor is receiving due to the movement of the sensor. In a situation where the sensor is receiving self-hit data even after applying a dilated mask, a machine learning model can detect that the sensor is receiving unwanted self-hit data by detecting a static portion of the frame that does not move within the frame (even as the AV continues to traverse the environment). In this case, the machine learning model can detect the self-hit data on the fly, and subsequently generate and apply a new binary mask based on the detection of the new self-hit data.

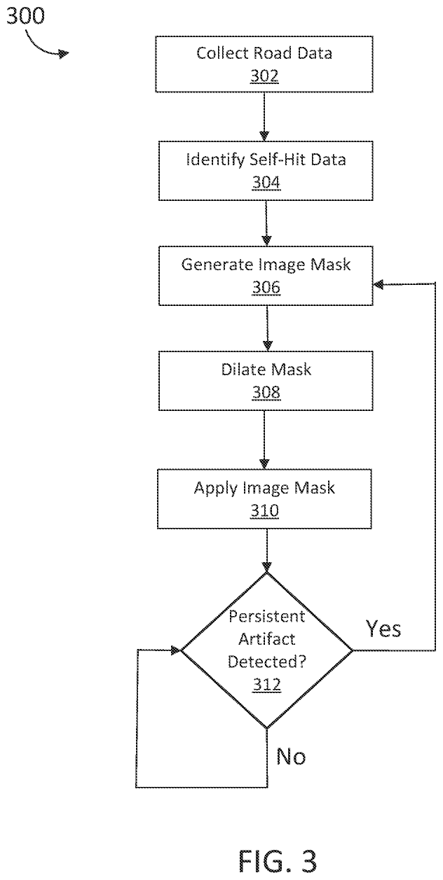

FIG. 3 illustrates a flow diagram of an example method 300 for detecting and filtering self-hit data of a sensor using a mask. At block 302, the process 300 can include using a sensor to collect road data. For example, one or more TOF sensors can be configured to collect sensor data of the surrounding environment. It is understood that although a TOF sensor is provided as an example of an AV sensor herein, any number of sensors, or different sensor types, may be implemented, without departing from the disclosed technology (such as, for example, LIDAR sensors). In the case where TOF sensors are used, sensor data can comprise data indicating a distance between the sensor and an object based on the time it takes for a signal to travel from the sensor to the object and back again.

At block 304, the process 300 can include identifying self-hit data within frames captured by the sensor. For example, a machine learning model can be trained to identify artifacts within a frame that appear in the same location in each and every other frame of the same field of view of the sensor as self-hit data. Due to the fact that the sensors are generally positioned in fixed locations about the body of the AV, the self-hit data generated by a given sensor can appear in the same location on each frame, each time the sensor completes a scan. Machine learning models can determine the number of frames comprising an identical, static artifact that is sufficient to distinguish between a real stationary object detected in the AV environment and an artifact of self-hit data.

At block 306, the process 300 can include generating a mask to filter out the unwanted self-hit data. For example, once the machine learning model has identified self-hit data for a particular sensor (e.g., block 304), the machine learning model can generate a fixed binary mask effectively blocking the self-hit data. In some examples, a machine learning model can be trained to generate a binary mask based on the identified self-hit data. For example, as discussed with reference to FIG. 1B, a mask can be generated for a sensor and the same mask can be applied to each and every frame of that sensor until the sensor itself is physically moved or it is determined that the mask needs to be recomputed, for example, due to changes in sensor calibration.

At block 308, the process 300 can include dilating the mask generated at block 306. As explained above, it can be helpful to perform a mask dilation after the mask has been generated to account for slight errors in sensor calibration and/or slight unintended movement of the sensor as it travels through an environment. In some cases, mask dilation can be the process of increasing the size of the mask (by a few extra pixels) within the frame mask to account for these errors and/or unintended movement of the sensor. For example, as the AV travels along a roadway it can hit a large pothole that can bump the location of one or more sensors positioned on the AV. Dilating the mask can account for these types of minor adjustments to the sensors.

At block 310, the process 300 can include applying the mask generated at block 306 (and, in some examples, dilated at block 308) to the frames captured by the sensor. Any method can be used to apply the generated mask to the frames such as, for example, multiplying the mask matrix against the collected field to zero-out the unwanted self-hit data. In some examples, the mask can be applied during operation of the AV stack, as discussed in more detail below. Applying the mask will filter out the unwanted self-hit data as described with reference to FIGS. 2A and 2B. As shown in FIG. 2B, the unwanted artifact 220 is no longer present in the frame. The lack of this unwanted artifact 220 can be important for the AV to accurately understand the environment around it when navigating the environment. As explained with regard to block 308, in some examples, the mask can be dilated prior to being applied to the frames.

At block 312, the process 300 can include monitoring the frames received based on the sensor data to determine if any persistent artifacts exist in the frames that can be classified as self-hit data. Similar to identifying self-hit data (e.g., block 304), this monitoring can identify self-hit data on-the-fly, as the AV traverses the environment. In some examples, an AV can be bumped (e.g., hit a pothole, collision with another object, etc.) and the mounted sensor's position can be altered. In this scenario, the self-hit data for that sensor will need to be identified again. Machine learning models can be implemented to monitor the frames to determine if any persistent artifacts exist in the frames that can be classified as self-hit data. If persistent artifacts exist (e.g., self-hit data), the process 300 can return to block 306 to generate a mask based on the newly identified self-hit data, the mask can be dilated (e.g., block 308), the mask can be applied (e.g., block 308), and the process can continue in the manner illustrated in FIG. 3. In the scenario where no persistent artifacts are found in the frames (at block 312), the process can continue monitoring the frames received to determine if any persistent artifacts are detected in the frames that can be classified as self-hit data to account for any inadvertent movement of the sensor.

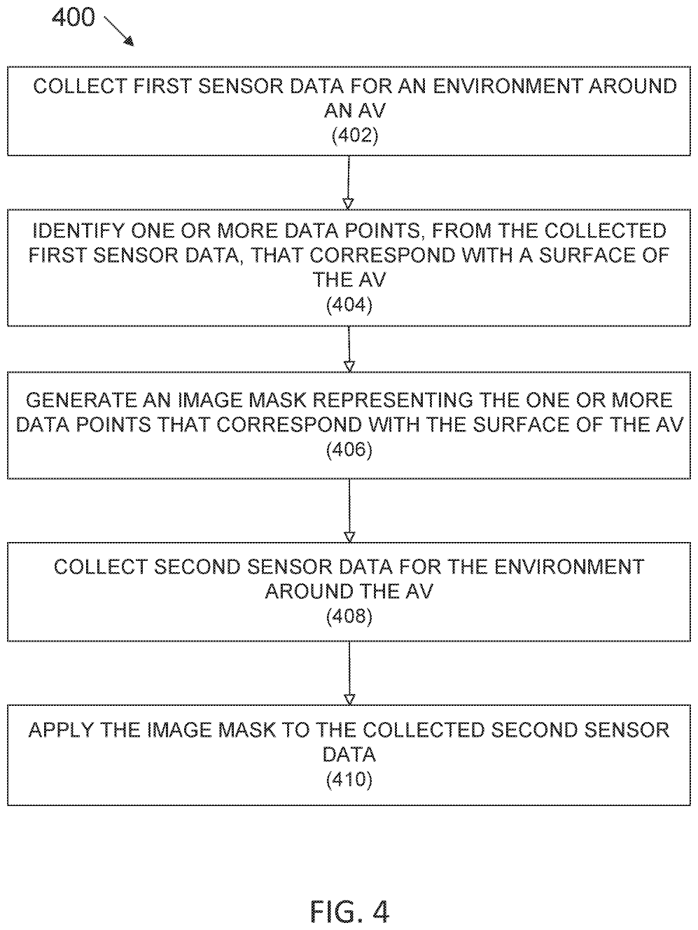

FIG. 4 illustrates a process 400 for identifying self-hit sensor data and generating a mask to filter out the self-hit sensor data. At block 402, the process 400 can include collecting first sensor data for an environment around an AV. For example, one or more TOF sensors can be configured to collect sensor data of the environment surrounding the AV. As discussed above, any number of sensors, or different sensor types, may be implemented, without departing from the disclosed technology. In the case where TOF sensors are used, sensor data can comprise data indicating a distance between the sensor and an object based on the time it takes for a signal to travel from the sensor to the object and back again.

At block 404, the process 400 can include identifying one or more data points, from the collected first sensor data, that correspond with a surface of the AV. In some examples, the one or more data points that correspond with a surface of the AV can be self-hit data. As discussed above, self-hit data can refer to data associated with measurements located on, or reflected from, a surface of the AV. To help distinguish between valid environmental sensor measurements (e.g., point clouds detecting objects location in the AV environment), and the one or more data points that correspond with a surface of the AV (e.g., self-hit data), machine learning models can be trained. For example, machine learning models can be trained to identify self-hit data. Since the sensors are positioned in fixed locations about the body of the AV, the self-hit data generated by a given sensor can appear in the same location on each frame, each time the sensor completes a scan. Therefore, in some scenarios, a machine learning model can be trained to identify artifacts within frames that appear in the same location in each and every frame as self-hit data.

At block 406, the process 400 can include generating a mask representing the one or more data points that correspond with the surface of the AV. Once the machine learning model has determined the location of self-hit data for a sensor, a machine learning model can generate a binary mask to the frames (such as frame 100 illustrated in FIG. 1A, for example) to filter out the self-hit data. For example, as illustrated in FIG. 1B, an example mask 110 can be generated to filter out the self-hit data (e.g., self-hit data 101 and self-hit data 102) identified in frame 100. In some examples, a machine learning model can be trained to generate a binary mask based on the identified self-hit data. For example, mask 110 shows mask portion 111 and mask portion 112 that, when overlayed onto frame 100, will block the unwanted self-hit data (e.g., self-hit data 101 and self-hit data 102). In view of the static location of each sensor on the AV, a mask can be generated for a sensor and the same mask can be applied to each and every frame of that sensor until the sensor itself is physically moved.

At block 408, the process 400 can include collecting second sensor data for the environment around the AV. The sensors collect data and measurements that the AV can use for operations such as navigation. The sensors can provide the data and measurements to an internal computing system of the AV, which can use the data and measurements to control a mechanical system of the autonomous vehicle, such as a vehicle propulsion system, a braking system, or a steering system. At block 410, the process 400 can include applying the mask to the collected second sensor data. For example, machine learning models can be trained to identify self-hit data, and generate and apply a mask to the sensor frames to filter out unwanted self-hit data. Any method can be used to apply the generated mask to newly captured frames (e.g., second sensor data for the environment around the AV) such as, for example, pixel-wise multiplication to remove self-hit artifacts from the collected frame. In some examples, the mask can be applied during operation of the AV stack, as discussed in more detail below. The application of the mask to the collected second sensor data can result in filtering out the unwanted identified one or more data points that correspond with a surface of the AV (e.g., self-hit data).

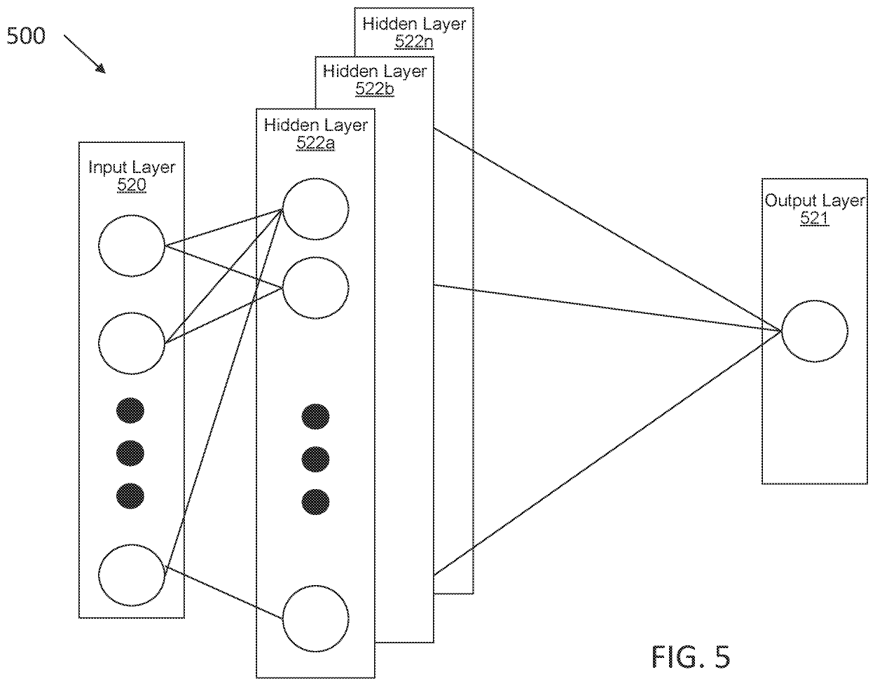

In FIG. 5, the disclosure now turns to a further discussion of models that can be used through the environments and techniques described herein. FIG. 5 is an example of a deep learning neural network 500 that can be used to implement all or a portion of the systems and techniques described herein (e.g., neural network 500 can be used to implement a model for detecting and filtering self-hit data of a sensor using a mask as discussed above). An input layer 520 can be configured to receive sensor data and/or data relating to an environment surrounding an AV. Neural network 500 includes multiple hidden layers 522a, 522b, through 522n. The hidden layers 522a, 522b, through 522n include “n” number of hidden layers, where “n” is an integer greater than or equal to one. The number of hidden layers can be made to include as many layers as needed for the given application. Neural network 500 further includes an output layer 521 that provides an output resulting from the processing performed by the hidden layers 522a, 522b, through 522n.

Neural network 500 is a multi-layer neural network of interconnected nodes. Each node can represent a piece of information. Information associated with the nodes is shared among the different layers and each layer retains information as information is processed. In some cases, the neural network 500 can include a feed-forward network, in which case there are no feedback connections where outputs of the network are fed back into itself. In some cases, the neural network 500 can include a recurrent neural network, which can have loops that allow information to be carried across nodes while reading in input.

Information can be exchanged between nodes through node-to-node interconnections between the various layers. Nodes of the input layer 520 can activate a set of nodes in the first hidden layer 522a. For example, as shown, each of the input nodes of the input layer 520 is connected to each of the nodes of the first hidden layer 522a. The nodes of the first hidden layer 522a can transform the information of each input node by applying activation functions to the input node information. The information derived from the transformation can then be passed to and can activate the nodes of the next hidden layer 522b, which can perform their own designated functions. Example functions include convolutional, up-sampling, data transformation, and/or any other suitable functions. The output of the hidden layer 522b can then activate nodes of the next hidden layer, and so on. The output of the last hidden layer 522n can activate one or more nodes of the output layer 521, at which an output is provided. In some cases, while nodes in the neural network 500 are shown as having multiple output lines, a node can have a single output and all lines shown as being output from a node represent the same output value.

In some cases, each node or interconnection between nodes can have a weight that is a set of parameters derived from the training of the neural network 500. Once the neural network 500 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 500 to be adaptive to inputs and able to learn as more and more data is processed.

The neural network 500 is pre-trained to process the features from the data in the input layer 520 using the different hidden layers 522a, 522b, through 522n in order to provide the output through the output layer 521.

In some cases, the neural network 500 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 500 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½ (target-output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 500 can perform a backward pass by determining which inputs (weights) most contributed to the loss of the network, and can adjust the weights so that the loss decreases and is eventually minimized.

The neural network 500 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 500 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

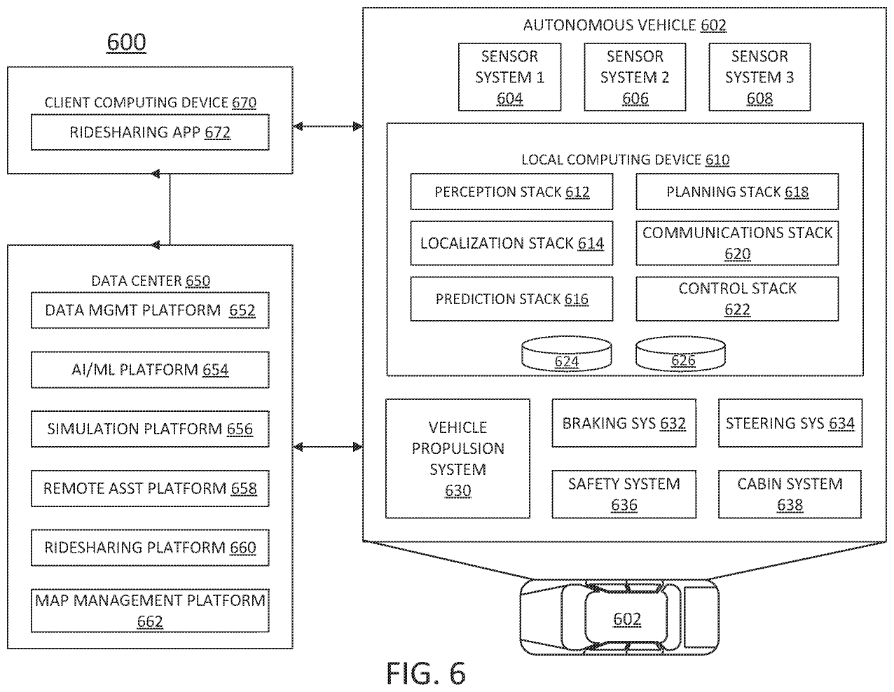

FIG. 6 is a diagram illustrating an example autonomous vehicle (AV) environment 600, according to some examples of the present disclosure. One of ordinary skill in the art will understand that, for AV environment 600 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 600 includes an AV 602, a data center 650, and a client computing device 670. The AV 602, the data center 650, and the client computing device 670 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 602 can navigate roadways without a human driver based on sensor signals generated by multiple sensor systems 604, 606, and 608. The sensor systems 604-608 can include one or more types of sensors and can be arranged about the AV 602. For instance, the sensor systems 604-608 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 604 can be a camera system, the sensor system 606 can be a LIDAR system, and the sensor system 608 can be a RADAR system. Other examples may include any other number and type of sensors.

The AV 602 can also include several mechanical systems that can be used to maneuver or operate the AV 602. For instance, the mechanical systems can include a vehicle propulsion system 630, a braking system 632, a steering system 634, a safety system 636, and a cabin system 638, among other systems. The vehicle propulsion system 630 can include an electric motor, an internal combustion engine, or both. The braking system 632 can include an engine brake, brake pads, actuators, and/or any other suitable componentry configured to assist in decelerating the AV 602. The steering system 634 can include suitable componentry configured to control the direction of movement of the AV 602 during navigation. The safety system 636 can include lights and signal indicators, a parking brake, airbags, and so forth. The cabin system 638 can include cabin temperature control systems, in-cabin entertainment systems, and so forth. In some examples, the AV 602 might not include human driver actuators (e.g., steering wheel, handbrake, foot brake pedal, foot accelerator pedal, turn signal lever, window wipers, etc.) for controlling the AV 602. Instead, the cabin system 638 can include one or more client interfaces (e.g., Graphical User Interfaces (GUIs), Voice User Interfaces (VUIs), etc.) for controlling certain aspects of the mechanical systems 630-638.

The AV 602 can include a local computing device 610 that is in communication with the sensor systems 604-608, the mechanical systems 630-638, the data center 650, and the client computing device 670, among other systems. The local computing device 610 can include one or more processors and memory, including instructions that can be executed by the one or more processors. The instructions can make up one or more software stacks or components responsible for controlling the AV 602; communicating with the data center 650, the client computing device 670, and other systems; receiving inputs from riders, passengers, and other entities within the AV's environment; logging metrics collected by the sensor systems 604-608; and so forth. In this example, the local computing device 610 includes a perception stack 612, a localization stack 614, a prediction stack 616, a planning stack 618, a communications stack 620, a control stack 622, an AV operational database 624, and an HD geospatial database 626, among other stacks and systems.

Perception stack 612 can enable the AV 602 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 604-608, the localization stack 614, the HD geospatial database 626, other components of the AV, and other data sources (e.g., the data center 650, the client computing device 670, third party data sources, etc.). The perception stack 612 can detect and classify objects and determine their current locations, speeds, directions, and the like. In addition, the perception stack 612 can determine the free space around the AV 602 (e.g., to maintain a safe distance from other objects, change lanes, park the AV, etc.). The perception stack 612 can identify environmental uncertainties, such as where to look for moving objects, flag areas that may be obscured or blocked from view, and so forth. In some examples, an output of the perception stack 612 can be a bounding area around a perceived object that can be associated with a semantic label that identifies the type of object that is within the bounding area, the kinematic of the object (information about its movement), a tracked path of the object, and a description of the pose of the object (its orientation or heading, etc.).

Localization stack 614 can determine the AV's position and orientation (pose) using different methods from multiple systems (e.g., GPS, IMUs, cameras, LIDAR, RADAR, ultrasonic sensors, the HD geospatial database 626, etc.). For example, in some cases, the AV 602 can compare sensor data captured in real-time by the sensor systems 604-608 to data in the HD geospatial database 626 to determine its precise (e.g., accurate to the order of a few centimeters or less) position and orientation. The AV 602 can focus its search based on sensor data from one or more first sensor systems (e.g., GPS) by matching sensor data from one or more second sensor systems (e.g., LIDAR). If the mapping and localization information from one system is unavailable, the AV 602 can use mapping and localization information from a redundant system and/or from remote data sources.

Prediction stack 616 can receive information from the localization stack 614 and objects identified by the perception stack 612 and predict a future path for the objects. In some examples, the prediction stack 616 can output several likely paths that an object is predicted to take along with a probability associated with each path. For each predicted path, the prediction stack 616 can also output a range of points along the path corresponding to a predicted location of the object along the path at future time intervals along with an expected error value for each of the points that indicates a probabilistic deviation from that point.

Planning stack 618 can determine how to maneuver or operate the AV 602 safely and efficiently in its environment. For example, the planning stack 618 can receive the location, speed, and direction of the AV 602, geospatial data, data regarding objects sharing the road with the AV 602 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 602 from one point to another and outputs from the perception stack 612, localization stack 614, and prediction stack 616. The planning stack 618 can determine multiple sets of one or more mechanical operations that the AV 602 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 618 can select from multiple backup plans to carry out. For example, while preparing to change lanes to turn right at an intersection, another vehicle may aggressively cut into the destination lane, making the lane change unsafe. The planning stack 618 could have already determined an alternative plan for such an event. Upon its occurrence, it could help direct the AV 602 to go around the block instead of blocking a current lane while waiting for an opening to change lanes.

Control stack 622 can manage the operation of the vehicle propulsion system 630, the braking system 632, the steering system 634, the safety system 636, and the cabin system 638. The control stack 622 can receive sensor signals from the sensor systems 604-608 as well as communicate with other stacks or components of the local computing device 610 or a remote system (e.g., the data center 650) to effectuate operation of the AV 602. For example, the control stack 622 can implement the final path or actions from the multiple paths or actions provided by the planning stack 618. This can involve turning the routes and decisions from the planning stack 618 into commands for the actuators that control the AV's steering, throttle, brake, and drive unit.

Communications stack 620 can transmit and receive signals between the various stacks and other components of the AV 602 and between the AV 602, the data center 650, the client computing device 670, and other remote systems. The communications stack 620 can enable the local computing device 610 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). Communications stack 620 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), Bluetooth®, infrared, etc.).

The HD geospatial database 626 can store HD maps and related data of the streets upon which the AV 602 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

AV operational database 624 can store raw AV data generated by the sensor systems 604-608, stacks 612-622, and other components of the AV 602 and/or data received by the AV 602 from remote systems (e.g., the data center 650, the client computing device 670, etc.). In some examples, the raw AV data can include HD LIDAR point cloud data, image data, RADAR data, GPS data, and other sensor data that the data center 650 can use for creating or updating AV geospatial data or for creating simulations of situations encountered by AV 602 for future testing or training of various machine learning algorithms that are incorporated in the local computing device 610.

Data center 650 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 650 can include one or more computing devices remote to the local computing device 610 for managing a fleet of AVs and AV-related services. For example, in addition to managing the AV 602, the data center 650 may also support a ride-hailing service (e.g., a ridesharing service), a delivery service, a remote/roadside assistance service, street services (e.g., street mapping, street patrol, street cleaning, street metering, parking reservation, etc.), and the like.

Data center 650 can send and receive various signals to and from the AV 602 and the client computing device 670. These signals can include sensor data captured by the sensor systems 604-608, roadside assistance requests, software updates, ride-hailing/ridesharing pick-up and drop-off instructions, and so forth. In this example, the data center 650 includes a data management platform 652, an Artificial Intelligence/Machine Learning (AI/ML) platform 654, a simulation platform 656, a remote assistance platform 658, and a ride-hailing platform 660, and a map management platform 662, among other systems.

Data management platform 652 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ride-hailing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 650 can access data stored by the data management platform 652 to provide their respective services.

The AI/ML platform 654 can provide the infrastructure for training and evaluating machine learning algorithms for operating the AV 602, the simulation platform 656, the remote assistance platform 658, the ride-hailing platform 660, the map management platform 662, and other platforms and systems. Using the AI/ML platform 654, data scientists can prepare data sets from the data management platform 652; select, design, and train machine learning models; evaluate, refine, and deploy the models; maintain, monitor, and retrain the models; and so on.

Simulation platform 656 can enable testing and validation of the algorithms, machine learning models, neural networks, and other development efforts for the AV 602, the remote assistance platform 658, the ride-hailing platform 660, the map management platform 662, and other platforms and systems. Simulation platform 656 can replicate a variety of driving environments and/or reproduce real-world scenarios from data captured by the AV 602, including rendering geospatial information and road infrastructure (e.g., streets, lanes, crosswalks, traffic lights, stop signs, etc.) obtained from a cartography platform (e.g., map management platform 662); modeling the behavior of other vehicles, bicycles, pedestrians, and other dynamic elements; simulating inclement weather conditions, different traffic scenarios; and so on.

Remote assistance platform 658 can generate and transmit instructions regarding the operation of the AV 602. For example, in response to an output of the AI/ML platform 654 or other system of the data center 650, the remote assistance platform 658 can prepare instructions for one or more stacks or other components of the AV 602.

Ride-hailing platform 660 can interact with a customer of a ride-hailing service via a ride-hailing application 672 executing on the client computing device 670. The client computing device 670 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ride-hailing application 672. The client computing device 670 can be a customer's mobile computing device or a computing device integrated with the AV 602 (e.g., the local computing device 610). The ride-hailing platform 660 can receive requests to pick up or drop off from the ride-hailing application 672 and dispatch the AV 602 for the trip.

Map management platform 662 can provide a set of tools for the manipulation and management of geographic and spatial (geospatial) and related attribute data. The data management platform 652 can receive LIDAR point cloud data, image data (e.g., still image, video, etc.), RADAR data, GPS data, and other sensor data (e.g., raw data) from one or more AVs 602, Unmanned Aerial Vehicles (UAVs), satellites, third-party mapping services, and other sources of geospatially referenced data. The raw data can be processed, and map management platform 662 can render base representations (e.g., tiles (2D), bounding volumes (3D), etc.) of the AV geospatial data to enable users to view, query, label, edit, and otherwise interact with the data. Map management platform 662 can manage workflows and tasks for operating on the AV geospatial data. Map management platform 662 can control access to the AV geospatial data, including granting or limiting access to the AV geospatial data based on user-based, role-based, group-based, task-based, and other attribute-based access control mechanisms. Map management platform 662 can provide version control for the AV geospatial data, such as to track specific changes that (human or machine) map editors have made to the data and to revert changes when necessary. Map management platform 662 can administer release management of the AV geospatial data, including distributing suitable iterations of the data to different users, computing devices, AVs, and other consumers of HD maps. Map management platform 662 can provide analytics regarding the AV geospatial data and related data, such as to generate insights relating to the throughput and quality of mapping tasks.

In some embodiments, the map viewing services of map management platform 662 can be modularized and deployed as part of one or more of the platforms and systems of the data center 650. For example, the AI/ML platform 654 may incorporate the map viewing services for visualizing the effectiveness of various object detection or object classification models, the simulation platform 656 may incorporate the map viewing services for recreating and visualizing certain driving scenarios, the remote assistance platform 658 may incorporate the map viewing services for replaying traffic incidents to facilitate and coordinate aid, the ride-hailing platform 660 may incorporate the map viewing services into the client application 672 to enable passengers to view the AV 602 in transit en route to a pick-up or drop-off location, and so on.

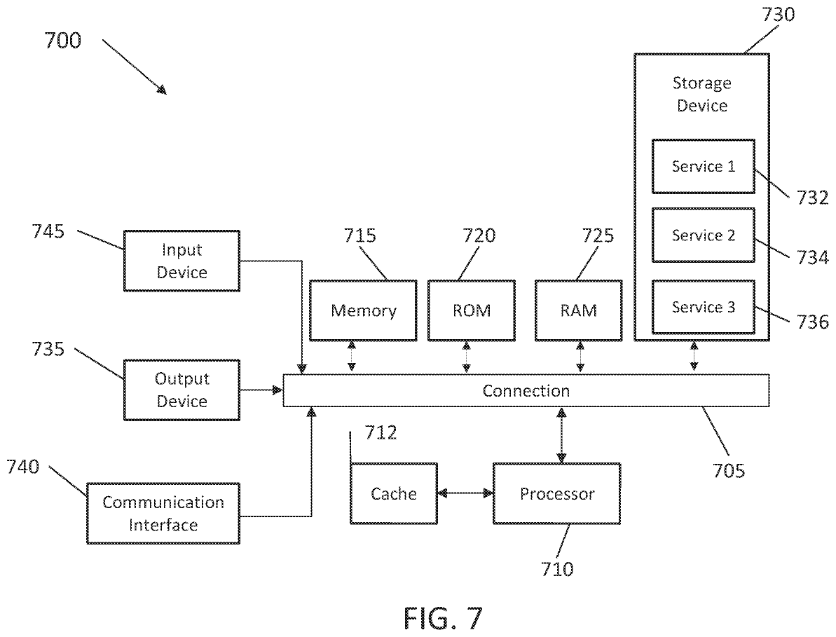

While the autonomous vehicle 602, the local computing device 610, and the autonomous vehicle environment 600 are shown to include certain systems and components, one of ordinary skill will appreciate that the autonomous vehicle 602, the local computing device 610, and/or the autonomous vehicle environment 600 can include more or fewer systems and/or components than those shown in FIG. 6. For example, the autonomous vehicle 602 can include other services than those shown in FIG. 6 and the local computing device 610 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 6. An illustrative example of a computing device and hardware components that can be implemented with the local computing device 610 is described below with respect to FIG. 7.

FIG. 7 illustrates an example processor-based system with which some aspects of the subject technology can be implemented. For example, processor-based system 700 can be any computing device making up, or any component thereof in which the components of the system are in communication with each other using connection 705. Connection 705 can be a physical connection via a bus, or a direct connection into processor 710, such as in a chipset architecture. Connection 705 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 700 includes at least one processing unit (Central Processing Unit (CPU) or processor) 710 and connection 705 that couples various system components including system memory 715, such as Read-Only Memory (ROM) 720 and Random-Access Memory (RAM) 725 to processor 710. Computing system 700 can include a cache of high-speed memory 712 connected directly with, in close proximity to, or integrated as part of processor 710.

Processor 710 can include any general-purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 730 can include software services, servers, services, etc., that when the code that defines such software is executed by the processor 710, it causes the system 700 to perform a function. In some embodiments, a hardware service that performs a particular function can include the software component stored in a computer-readable medium in connection with the necessary hardware components, such as processor 710, connection 705, output device 735, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### Illustrative Examples of the Disclosure Include

Aspect 1. A system comprising: at least one memory; and at least one processor coupled to the at least one memory, the at least one processor configured to: collect first sensor data for an environment around an autonomous vehicle (AV); identify one or more data points, from the collected first sensor data, that correspond with a surface of the AV; generate an image mask representing the one or more data points that correspond with the surface of the AV; collect second sensor data for the environment around the AV; and apply the image mask to the collected second sensor data.

Aspect 2. The system of Aspect 1, further comprising: identifying the one or more data points from among the collected first sensor data as self-hit data points.

Aspect 3. The system of Aspect 1 or 2, wherein a machine learning model identifies the one or more data points that correspond with a surface of the AV.

Aspect 4. The system of any of Aspects 1 to 3, wherein the image mask is generated using a machine learning model.

Aspect 5. The system of any of Aspects 1 to 4, wherein the image mask is dilated before it is applied to the collected second sensor data.

Aspect 6. The system of any of Aspects 1 to 5, wherein the sensor data comprises time of flight (TOF) data.

Aspect 7. The system of any of Aspects 1 to 6, wherein a machine learning model determines a within a frame between the AV and the environment.

Aspect 8. A method comprising: collecting first sensor data for an environment around an autonomous vehicle (AV); identifying one or more data points, from the collected first sensor data, that correspond with a surface of the AV; generating an image mask representing the one or more data points that correspond with the surface of the AV; collecting second sensor data for the environment around the AV; and applying the image mask to the collected second sensor data.

Aspect 9. The method of Aspect 8, further comprising: identifying the one or more data points from among the collected first sensor data as self-hit data points.

Aspect 10. The method of Aspect 8 or 9, wherein a machine learning model identifies the one or more data points that correspond with a surface of the AV.

Aspect 11. The method of any of Aspects 8 to 10, wherein the image mask is generated using a machine learning model.

Aspect 12. The method of any of Aspects 8 to 11, wherein the image mask is dilated before it is applied to the collected second sensor data.

Aspect 13. The method of any of Aspects 8 to 12, wherein the sensor data comprises time of flight (TOF) data.

Aspect 14. The method of any of Aspects 8 to 13, wherein a machine learning model determines a within a frame between the AV and the environment.

Aspect 15. A non-transitory computer-readable storage medium comprising at least one instruction for causing a computer or processor to: collect first sensor data for an environment around an autonomous vehicle (AV); identify one or more data points, from the collected first sensor data, that correspond with a surface of the AV; generate an image mask representing the one or more data points that correspond with the surface of the AV; collect second sensor data for the environment around the AV; and apply the image mask to the collected second sensor data.

Aspect 16. The non-transitory computer-readable storage medium of Aspect 15, further comprising: identifying the one or more data points from among the collected first sensor data as self-hit data points.

Aspect 17. The non-transitory computer-readable storage medium of Aspect 15 or 16, wherein a machine learning model identifies the one or more data points that correspond with a surface of the AV.

Aspect 18. The non-transitory computer-readable storage medium of any of Aspects 15 to 17, wherein the image mask is generated using a machine learning model.

Aspect 19. The non-transitory computer-readable storage medium of any of Aspects 15 to 18, wherein image mask is dilated before it is applied to the collected second sensor data.

Aspect 20. The non-transitory computer-readable storage medium of any of Aspects 15 to 19, wherein the sensor data comprises time of flight (TOF) data.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A system comprising:
at least one memory; and
at least one processor coupled to the at least one memory, the at least one processor configured to:
collect first sensor data for an environment around an autonomous vehicle (AV);
identify one or more data points, from the collected first sensor data, that correspond with a surface of the AV;
generate an image mask representing the one or more data points that correspond with the surface of the AV;
collect second sensor data for the environment around the AV; and
apply the image mask to the collected second sensor data.

2. The system of claim 1, further comprising:
identifying the one or more data points from among the collected first sensor data as self-hit data points.

3. The system of claim 1, wherein a machine learning model identifies the one or more data points that correspond with a surface of the AV.

4. The system of claim 1, wherein the image mask is generated using a machine learning model.

5. The system of claim 1, wherein the image mask is dilated before it is applied to the collected second sensor data.

6. The system of claim 1, wherein the sensor data comprises time of flight (TOF) data.

7. The system of claim 1, wherein a machine learning model determines a within a frame between the AV and the environment.

8. A method comprising:
collecting first sensor data for an environment around an autonomous vehicle (AV);
identifying one or more data points, from the collected first sensor data, that correspond with a surface of the AV;
generating an image mask representing the one or more data points that correspond with the surface of the AV;
collecting second sensor data for the environment around the AV; and
applying the image mask to the collected second sensor data.

9. The method of claim 8, further comprising:
identifying the one or more data points from among the collected first sensor data as self-hit data points.

10. The method of claim 8, wherein a machine learning model identifies the one or more data points that correspond with a surface of the AV.

11. The method of claim 8, wherein the image mask is generated using a machine learning model.

12. The method of claim 8, wherein the image mask is dilated before it is applied to the collected second sensor data.

13. The method of claim 8, wherein the sensor data comprises time of flight (TOF) data.

14. The method of claim 8, wherein a machine learning model determines a within a frame between the AV and the environment.

15. A non-transitory computer-readable storage medium comprising at least one instruction for causing a computer or processor to:
collect first sensor data for an environment around an autonomous vehicle (AV);
identify one or more data points, from the collected first sensor data, that correspond with a surface of the AV;
generate an image mask representing the one or more data points that correspond with the surface of the AV;
collect second sensor data for the environment around the AV; and
apply the image mask to the collected second sensor data.

16. The non-transitory computer-readable storage medium of claim 15, further comprising:
identifying the one or more data points from among the collected first sensor data as self-hit data points.

17. The non-transitory computer-readable storage medium of claim 15, wherein a machine learning model identifies the one or more data points that correspond with a surface of the AV.

18. The non-transitory computer-readable storage medium of claim 15, wherein the image mask is generated using a machine learning model.

19. The non-transitory computer-readable storage medium of claim 15, wherein the image mask is dilated before it is applied to the collected second sensor data.

20. The non-transitory computer-readable storage medium of claim 15, wherein the sensor data comprises time of flight (TOF) data.
